(19) United States
(12) Patent Application Publication
(10) Pub. No.: US 2026/0127523 A1
(43) Pub. Date: May 7, 2026

(54) VIRTUAL NATURAL LANGUAGE PROCESSING-BASED MULTI-TASK AGENT

(71) Applicant: AI21 LABS, Tel-Aviv (IL)

(72) Inventors: Amnon MORAG, Tel-Aviv (IL); Roee COHEN, Tel-Aviv (IL); Ori GOSHEN, Tel-Aviv (IL); Yoav SHOHAM, Tel-Aviv (IL); Or DAGAN, Tel-Aviv (IL); Dan PADNOS, Tel-Aviv (IL)

(21) Appl. No.: 19/437,597

(22) Filed: Dec. 31, 2025

Related U.S. Application Data
(63) Continuation of application No. PCT/US2024/040335, filed on Jul. 31, 2024.
(60) Provisional application No. 63/529,803, filed on Jul. 31, 2023.

(51) Int. Cl. G06Q 10/0631; G06F 11/34; G06Q 10/0633

(52) U.S. Cl. CPC G06Q 10/06316; G06F 11/3438; G06Q 10/0633

(57) ABSTRACT

A non-transitory computer-readable medium may include instructions that when executed by one or more processing devices cause the one or more processing devices to perform a method. The method may include receiving an identifier of at least one task. The method may further include determining, by a planner component, a planning flow, wherein the planning flow comprises a series of steps determined based on the identifier of the at least one task and information associated with at least one resource, and wherein the planner component is further configured to access one or more trained models providing a natural language processing function. The method may further include causing one or more execution components to execute the planning flow by accessing or using the at least one resource in order to generate at least one output using the one or more trained models.

### CROSS-REFERENCE TO RELATED APPLICATIONS

This application is a continuation of International Application No. PCT/US 2024/040335, filed Jul. 31, 2024, which claims priority from U.S. Provisional Ser. No. 63/529,803, filed on Jul. 31, 2023. The disclosures of the above-referenced applications are incorporated herein by reference in their entireties.

### BACKGROUND

The disclosed technology relates generally to virtual artificial intelligence (AI)-based agents. Previous systems have allowed users to engage with virtual AI-based agents to accomplish tasks. However, such systems have lacked features that enable users to observe and modify a planning flow created by the agent before the execution of the task. Instead, users of these systems are unable to scrutinize, provide comments, or amend a planning flow generated by the agent for a particular task. Without this capability, the agent would execute the task with numerous mistakes or irrelevant parameters that could not be identified by the user. This inadequacy of prior systems often resulted in unsatisfactory outputs since users had no means of reviewing the execution method of the agent. The present embodiments seek to remedy these inadequacies of previous systems.

### SUMMARY

Some of the presently disclosed embodiments may include a non-transitory computer-readable medium including instructions that when executed by one or more processing devices cause the one or more processing devices to perform a method, the method including: receiving an identifier of at least one task; determining, by a planner component, a planning flow, wherein the planning flow comprises a series of steps determined based on the identifier of the at least one task and information associated with at least one resource, and wherein the planner component is further configured to access one or more trained models providing a natural language processing function; and causing one or more execution components to execute the planning flow by accessing or using the at least one resource in order to generate at least one output using the one or more trained models.

Some of the presently disclosed embodiments may include a non-transitory computer-readable medium including instructions that when executed by one or more processing devices cause the one or more processing devices to perform a method, the method including: receiving an identifier of at least one task; determining, by a planner component, a planning flow, wherein the planning flow comprises a series of steps determined based on the identifier of the at least one task and information associated with at least one resource, and wherein the planner component is further configured to access one or more trained models providing a natural language processing function; causing the planning flow to be communicated to a user; receiving at least one user-generated comment related to the planning flow; based on analysis of the at least one user-generated comment, determining, by the planner component, an edited planning flow, wherein the edited planning flow is determined based on at least one aspect of the at least one user-generated comment; and causing one or more execution components to execute the edited planning flow by accessing or using the at least one resource in order to generate at least one output using the one or more trained models.

### BRIEF DESCRIPTION OF DRAWING(S)

FIG. 1 is a diagram illustrating an exemplary system environment in which the disclosed AI-based agent may be used, consistent with disclosed embodiments.

FIGS. 2A, 2B, 2C, and 2D provide diagrammatic representations of configuring an AI-based agent according to disclosed embodiments.

FIG. 3 provides a diagrammatic representation of an AI-based agent interface according to disclosed embodiments.

FIG. 4 is a flowchart showing an example method of performing a task using an AI-based agent according to disclosed embodiments.

FIGS. 5A, 5B, 5C, and 5D provide diagrammatic representations of interacting with an AI-based agent according to disclosed embodiments.

FIG. 6 is a flowchart showing an example method of performing a task using an AI-based agent according to disclosed embodiments.

FIG. 7 provides a diagrammatic representation of interacting with an AI-based agent according to disclosed embodiments.

### DETAILED DESCRIPTION

The disclosed embodiments relate to a virtual AI-based agent that may execute a variety of multimodal tasks for a multitude of users. For many individuals, undertaking numerous intricate tasks can be an arduous and time-consuming requirement of their personal or professional lives. For instance, employees within an organization may be obligated to undertake a number of dissimilar tasks such as scheduling, research, generating forecasts, or conducting analyses. With so many intricate tasks to attend to, it can be a challenge for a solitary worker to perform each task meticulously while adhering to its respective deadline.

To address this issue, the disclosed embodiments introduce systems and methods for interacting with an AI-based agent comprising a planner component and one or more execution components that utilizes one or more trained models capable of delivering natural language processing (NLP) functionality that, when given a user-task, can execute the task with adeptness. The planner component may provide the user with a planning flow that it has determined based on the objective, thereby allowing the user to review the steps the one or more execution components may take to accomplish the task. This feature may allow the user to provide feedback to the planner component, which it can utilize to generate a revised or updated planning flow, resulting in the one or more execution components executing the given task with greater precision and quality.

Natural language processing (NLP) is a technology that allows computers to understand, interpret and manipulate human language. By using advanced algorithms, NLP can analyze and interpret text or speech, allowing computers to recognize patterns, identify concepts, and even generate language. Machine learning models are a type of NLP that use data and statistical algorithms to learn from experience. As these models are exposed to more examples (i.e., trained), they become better at recognizing patterns and making predictions.

Large language models (LLMs) are a more advanced type of machine learning model that use massive amounts of data to develop a deep understanding of language. These models can generate new text that is similar in style and tone to human language. They are able to do this by analyzing patterns in the way we use language, such as common word usage, sentence structure, and grammar. By using NLP trained machine learning models and large language models, tasks like language translation, speech recognition, and chatbot interactions can be automated.

The presently disclosed AI-based agent may comprise a planner component and one or more execution components. Each component may include one or more software modules (e.g., program instructions). The planner component of the AI-based agent may be configured to access one or more trained models providing a natural language function and at least one resource to determine a planning flow based on at least one task that the AI-agent has received. The one or more execution components of the AI-based agent may be configured to then execute the planning flow in order to generate at least one output for the at least one task. The planning flow and the one or more execution components can be included in an application or in an application programming interface (API).

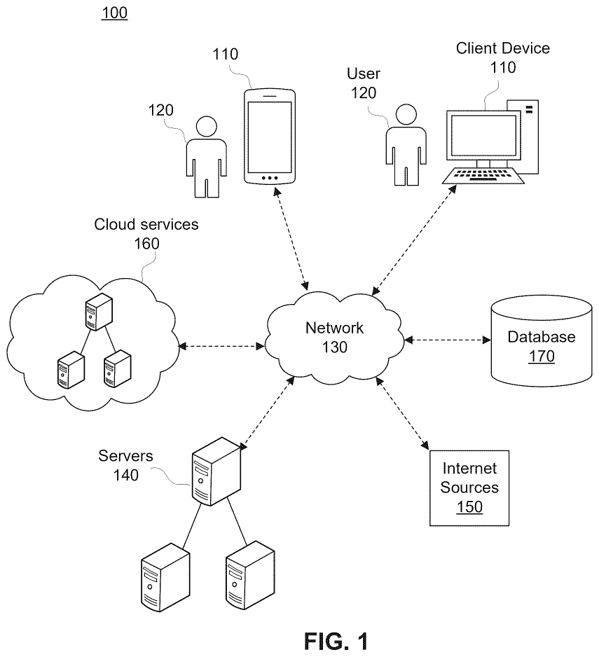

FIG. 1 is a schematic diagram of an exemplary system environment in which the disclosed AI-based agent may be employed, consistent with the disclosed embodiments. For example, system 100 may include a plurality of client devices 110 operated by users 120. System 100 may also include a network 130, server 140, internet resources 150, cloud services 160, and databases 170. The components and arrangement of the components included in system 100 may vary. Thus, system 100 may include any number or any combination of the system environment components shown or may include other components or devices that perform or assist in the performance of the system or method consistent with the disclosed embodiments. The components and arrangements shown in FIG. 1 are not intended to limit the disclosed embodiments, as the components used to implement the disclosed processes and features may vary. Additionally, the disclosed AI-based agent may be implemented on any single component shown (e.g., a single mobile device or single PC included in client devices 110) or may be implemented in a network architecture (e.g., one or more features of the disclosed methods being implemented on a server 140, associated with one or more cloud services 160, etc. and having connectivity established with one or more client devices 110 via network 130 (e.g., a WAN, LAN, Internet connection, etc.)).

As shown in FIG. 1, client devices 110 may include a variety of different types of devices, such as personal computers, mobile devices like smartphones, tablets, and smartwatches, client terminals, supercomputers, etc. Client devices 110 may be connected to a network such as network 130. In some cases, a user 120 may access the AI-based agent and its associated functionality via the client device 110 which can display the user interface of the AI-based agent or can display an application accessing the AI-based agent via an application programming interface (API).

Network 130, in some embodiments, may comprise one or more interconnected wired or wireless data networks that receive data from one device (e.g., client devices 110) and send it to another device (e.g., servers 140). For example, network 130 may be implemented to include one or more Internet communication paths, a wired Wide Area Network (WAN), a wired Local Area Network (LAN), a wireless LAN (e.g., Bluetooth®, etc.), or the like. Each component in system 100 may communicate bidirectionally with other system 100 components either through network 130 or through one or more direct communication links (not shown).

The disclosed AI-based agent may be implemented and run using a variety of different equipment, such as one or more servers, personal computers, mobile devices, supercomputers, mainframes, or the like, connected via various types of networks. In some embodiments, the AI-based agent may be configured to receive information from client device 110, database 170, server 140, cloud service 160, and/or Internet sources 150 (among others) and send or return information to the same. The AI-based agent can be incorporated into client devices 110 and run locally or be run on a server 140 or from a cloud service 160 accessed by the client device 110 via network 130.

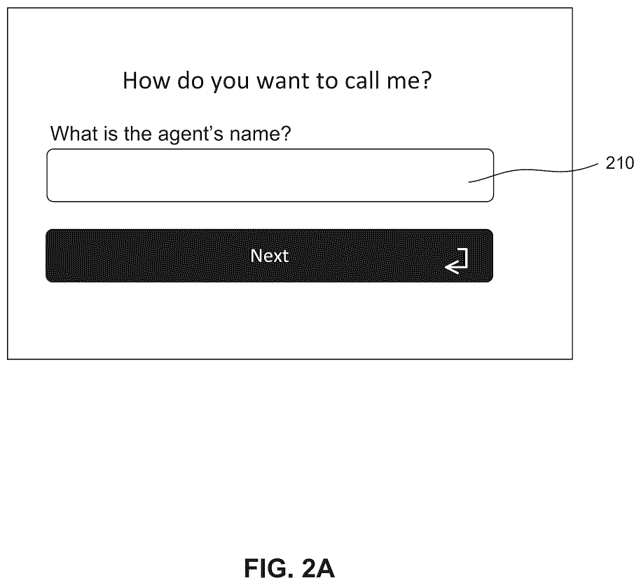

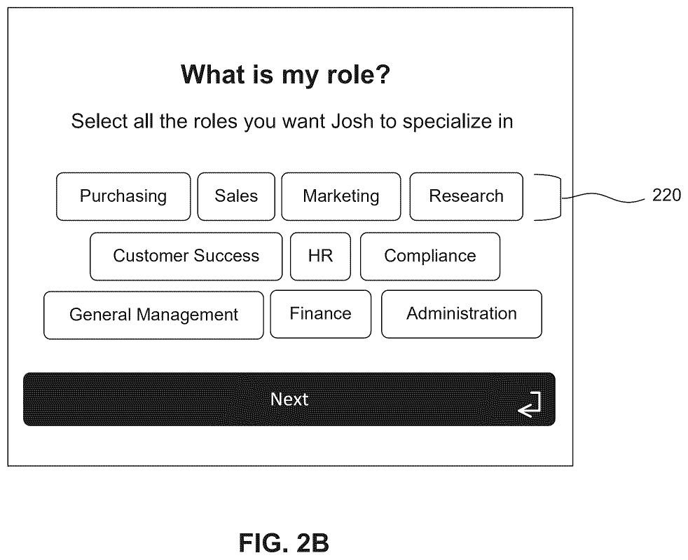

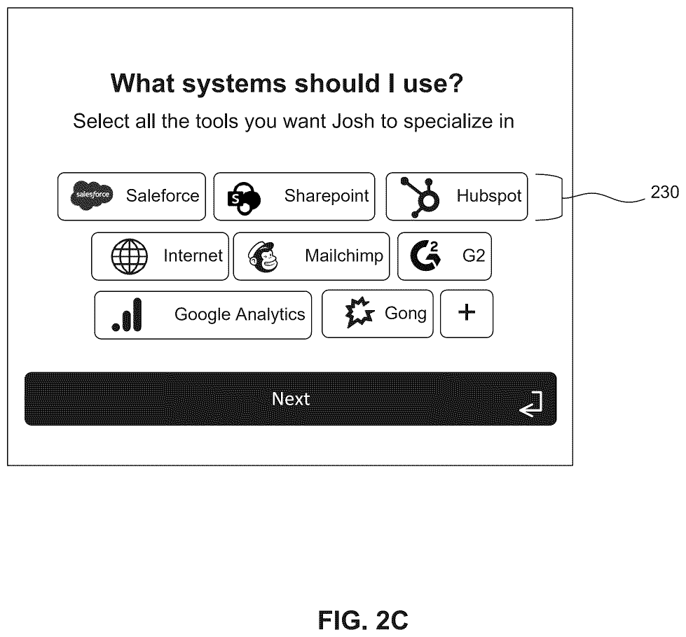

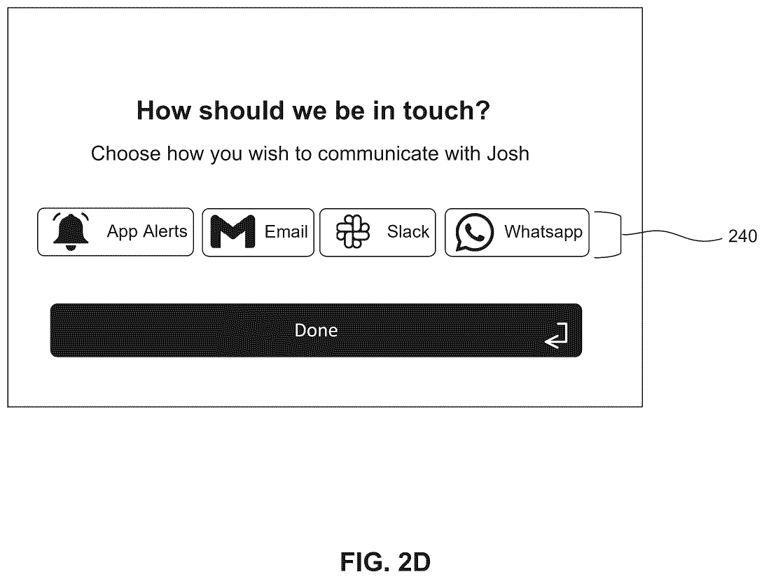

In the disclosed embodiments, the AI-based agent can be configured to perform tasks surrounding a specialized subject. In some embodiments, a user can configure the AI-based agent. FIGS. 2A-2D show interfaces associated with exemplary embodiments of the disclosed AI-based agent. The exemplary actions for configuring an AI-based agent represented in FIGS. 2A-2D can be performed in any order.

FIG. 2A represents an example interface associated with configuring an AI-based agent, wherein the AI-based agent comprises a planner component and one or more execution components. In this example interface, at text entry field 210, a name for the AI-based agent may be submitted. In an embodiment, the AI-based agent name may be submitted in the form of audio. In a further embodiment, the AI-based agent name may be submitted via a button selection within a graphical user interface (GUI). In some embodiments, after an AI-based agent name is submitted, the AI-based agent may begin to be referred to by the submitted name in subsequent interactions.

FIG. 2B represents another example interface associated with configuring an AI-based agent. In this example interface, at least one subject is chosen for the AI-based agent to be configured on. In some embodiments, the AI-based agent may specialize in performing tasks that are specific to the selected at least one subject. In some embodiments, the at least one subject can be chosen via a button 220 of a GUI. In other embodiments, the at least one subject can be submitted via text or audio. Examples of the subjects the AI-based agent can specialize in include, but are not limited to, “purchasing”, “sales”, “marketing”, “research”, “customer success”, “human resources (HR)”, “compliance”, “general management”, “finance” or “administration”.

FIGS. 2C and 2D represent yet more example interfaces associated with configuring an AI-based agent. In both FIGS. 2C and 2D, at least one resource (e.g., a tool) which the planner component of the AI-based agent is configured to access may be chosen. For example, a user may choose any number of resources 230 which the planner component can subsequently access to acquire information from in order for the one or more execution components of the AI-based agent to execute a specific task. These resources may include, but are not limited to, a word processor program, an electronic mail account, an instant messaging platform, a database, or an online source. In some embodiments, the database is associated with organizational information or personal information of a user. In some embodiments, once the at least one resource is chosen, the planner component of the AI-based agent may be configured to extract information from the at least one resource using one or more trained models providing a natural language processing function. In some embodiments, the one or more trained models include one or more trained machine learning models. In some embodiments, these one or more trained machine learning models include one or more large language models (LLMs). In some embodiments, the one or more execution components can store the extracted information in a memory associated with the AI-based agent. In FIG. 2D, a selected resource 240 allows the one or more execution components to communicate with at least one user outside of an application of the AI-based agent or an API associated with the AI-based agent.

In the disclosed embodiments, once the AI-based agent has been configured, it may process, via the planner component, information it is permitted to access from the at least one resource and extract information, which may then be stored in a long-term memory, via the one or more execution components, associated with the AI-based agent. In some embodiments, this extracted information is associated with the at least one subject the AI-based agent is configured on. In some embodiments, this extracted information can then be accessed by the one or more execution components for executing future tasks. In yet more embodiments, this extracted information includes both organizational and personal data pertaining to the user. Additionally, the one or more execution components may allow the user to view the stored extracted information at any time. In some embodiments, the access of the planner component to the at least one resource may be configurable by a user. For example, the user may revoke access to at least one resource or allow the planner component to access an additional at least one resource.

In some embodiments, a user may also specify additional topics relating to the at least one subject which they want the planner component of the AI-based agent to research from the information accessible in the at least one resource. The AI-based agent may use these additional topics to enhance its knowledge of subject matters that are important for performing certain tasks. In some embodiments, the one or more execution components of the AI-based agent may also suggest such potential topics to a user, based on the information previously processed by the planner component.

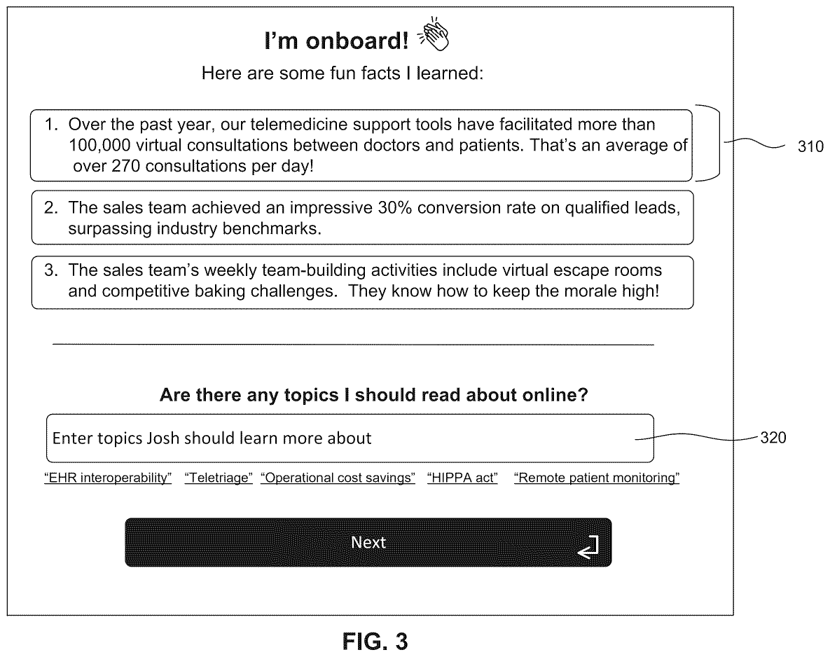

FIG. 3 illustrates an example interface after configuration of AI-based agent. In this example interface, the AI-based agent, post configuration, displays a number of facts 310 it has learned after using trained models providing a natural language processing function to access information from the at least one resource, via its planner component, pertaining to the chosen at least one subject. Further in FIG. 3, for example, the interface at text entry field 320 allows for additional topics relating to the at least one subject to be submitted. The submission of additional topics results in the planner component researching from all the accessible information from the at least one resource to find information relating to the additional topics.

In the present disclosure, the AI-based agent may automatically determine, via its planner component, a multi-step plan to execute a task it is given, which may be subsequently followed when executing the given task via the one or more execution components of the AI-based agent. In some embodiments, the one or more execution components of the AI-based agent may ask a human user to review the determined plan before it starts executing any of the steps.

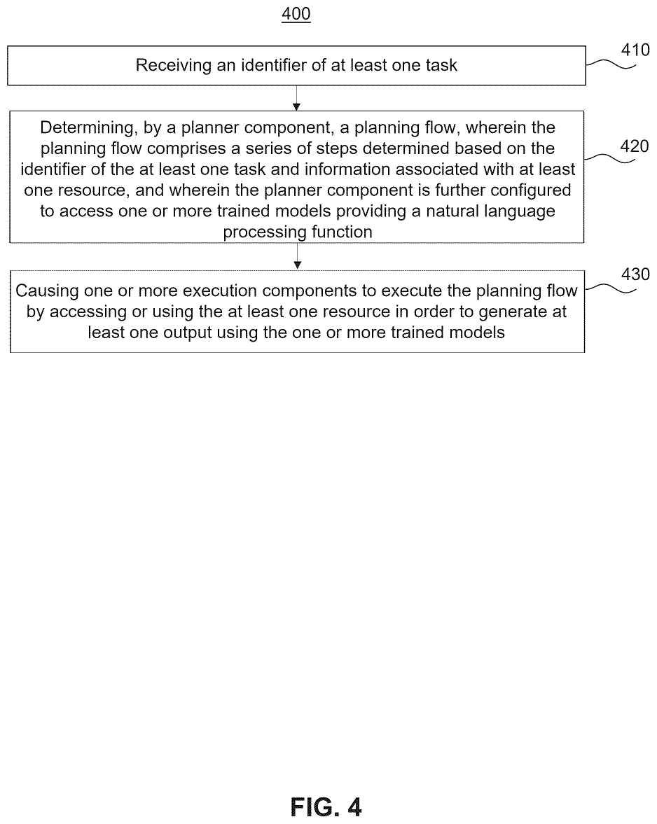

FIG. 4 is a flowchart showing exemplary method 400 of performing a task using an AI-based agent, according to embodiments of the present disclosure. Method 400 may be performed by at least one processing device of a computing device (e.g., client device 110 or servers 140 of system 100). It is to be understood that throughout the present disclosure, the term “processor” is used as a shorthand for “at least one processor” or “one or more processors.” In other words, a processor may include one or more structures that perform logic operations whether such structures are collocated, connected, or dispersed. In some embodiments, a non-transitory computer readable medium may contain instructions that when executed by a processor cause the processor to perform method 400. Further, method 400 is not necessarily limited to the steps shown in FIG. 4, and any steps or processes of the various embodiments described throughout the present disclosure may also be included in method 400.

In some embodiments, method 400 begins at step 410 as shown in FIG. 4. At step 410, one or more processing devices of system 100 receives an identifier of at least one task. The identifier of the at least one task may include any alphameric information. For example, the identifier of the at least one task may include a name of a task or a type of task.

Next, at step 420 of method 400, the one or more processing devices of system 100 determine, by a planner component, a planning flow. The planning flow may comprise a series of steps determined based on the identifier of the at least one task and information associated with at least one resource. The planner component may be further configured to access one or more trained models providing a natural language processing function.

Next, at step 430 of method 400, the one or more processing devices of system 100 cause one or more execution components to execute the planning flow by accessing or using the at least one resource in order to generate at least one output using the one or more trained models.

In some embodiments, the identifier of the at least one task is received from a user interacting with the AI-based agent. In some embodiments, the planner component and the one or more execution components of the AI-based agent are included in an API. For example, a user with a personal application may connect the planner component and the one or more execution components API to a personal application in order to use the AI-based agent via their personal application. In some embodiments, the planner component and the one or more execution components are included in an application. For example, the one or more execution components of the planner component and the one or more execution components of the AI-based agent are included in a standalone application with its own GUI with which the user can interact. In some embodiments, the identifier is based on at least one of the user selecting a button within a GUI, the user submitting text within a text input window of a GUI, or the user submitting an audio input. For example, a user interacting with the AI-based agent may submit a task via a text entry window of a GUI, may upload an audio recording containing a task, may record in real-time audio containing a task or may select from a number of pre-defined tasks using buttons within a GUI. In some embodiments, the GUI may be a GUI of the AI-based agent, a GUI of the at least one resource, or a GUI of a personal application of the user. For example, a user that has connected an API of the AI-based agent to their personal application may interact with the AI-based agent using the GUI of their personal application. In some embodiments, the identifier includes a description of the at least one task.

In some embodiments, the at least one task includes configuring the AI-based agent. For example, the user interacting with an AI-based may ask the AI-based agent to configure itself according to certain user-defined parameters. In some embodiments, the at least one-task is text-based or audio-based. In some embodiments, the at least one task comprises one or more of a scheduling task, a research task, an administering a survey to other users task, a requesting other users for information task, a generating a forecast task, or a providing an analysis task.

In some embodiments, the one or more trained models include one or more trained machine learning models. In some embodiments, these one or more trained machine learning models include one or more large language models (LLMs).

In some embodiments, determining the planning flow includes analyzing, using the one or more trained models, API documentation associated with an API of the at least one resource. For example, using one or more trained models providing a natural language processing function, the planner component can analyze and learn from documentation associated with an API of the at least one resource in order to connect the AI-based agent with the API of the at least one resource and subsequently access the information of the at least one resource in order to determine the planning flow.

In some embodiments, method 400 further comprises tracking a behavior of a user when accessing the at least one resource. For example, the planner component and/or the one or more execution components using one or more trained models can track the actions of a user interacting with, for example, a GUI of the at least one resource and subsequently learn how to independently use the GUI of the at least one resource in order for the planner component and/or the one or more execution components to access the information of the at least one resource.

In yet more embodiments, the user can provide the planner component with examples of how to access or use the at least one resource. For example, the user may submit to the AI-based agent examples of how to access or use the at least one resource, allowing the planner component to learn from the examples and subsequently independently access or use the at least one resource in order to, for example, access information of the at least one resource, or perform actions within the at least one resource.

In some embodiments, the method 400 further comprises causing the planning flow to be shown to a user. In some embodiments, the planning flow is shown to the user via a display or via audio. For example, the user may be given the option to view the planning flow on a display or listen to a description or summary of the planning flow in order to review the planning flow. In some embodiments, the display may show the planning flow via the GUI of the at least one resource, the GUI of the AI-based agent, or the GUI of a personal application of the user.

In some embodiments, the at least one output conveys a meaning associated with at least one portion of the information associated with the at least one resource.

In some embodiments, exemplary method 400 further comprises causing the at least one output to be shown to a user via a display. Causing the at least one output to be shown to the user via a display may comprise causing the at least one output to be shown to the user via a GUI.

In some embodiments, the at least one output generated by the one or more execution components includes one or more of text, an image, a video, an electronic mail message, audio, or code. In some embodiments, the at least one output includes causing an application to perform at least one action. For example, the generated output may comprise the one or more execution components interacting with at least one resource in order to carry out an action within or using the at least one resource. The at least one action can include, but is not limited to, updating an electronic calendar, editing a database, generating a proposal, generating a presentation, generating an executive summary, generating instructions for a product, among other things.

In some embodiments, method 400 further comprises extracting information associated with the at least one resource and storing the extracted information in a memory accessible by the one or more execution components. In some embodiments, the extracted information is visible to a user. In some embodiments, the extracted information can be shown to a user via a display. For example, the user can view the extracted information via a GUI on a display. In some embodiments, the extracted information is inaccessible to users who do not have permission to access the extracted information. Permission to access the extracted information may be granted (or denied) via a user interface.

In some embodiments, the planning flow is further based on at least one subject. In other embodiments, the at least one subject can be submitted via text or audio. Examples of the subjects the one or more execution components can specialize in include, but are not limited to, “purchasing”, “sales”, “marketing”, “research”, “customer success”, “human resources (HR)”, “compliance”, “general management”, “finance” or “administration”.

In some embodiments, the at least one resource includes one or more of a word processor program, an electronic mail account, an instant messaging platform, a database, or an online source.

In some embodiments, the one or more execution components are configured to execute the planning flow in response to an instruction received from a user. The instruction may include a request for information or a request to perform at least one action.

In some embodiments, a user is able to test an ability of the planner component to access information associated with the at least one resource.

In some embodiments, the AI-based agent is further configured to interact sequentially with a plurality of users. For example, the AI-based agent can communicate with any number of users within a messaging platform pre-defined as an at least one resource configured to allow communication between members of a group, such as a group chat. In some embodiments, method 400 further comprises receiving an instruction from the user granting permission for a communication history between the user and the one or more execution components to be accessed by other users. In some embodiments, method 400 further comprises receiving an instruction from a user denying permission for the communications history between the user and the one or more execution components to be accessed by other users. In some embodiments, the other users comprise users inside a same organization as the user or users outside the organization of the user. For example, other users may be colleagues of the user in the same organization or may be outside the organization entirely.

In some embodiments, the AI-based agent may not expose extracted information from the at least one resource to another user who does not have permissions to access the information that served the AI-based agent in the completion of the task. For example, when the user gives the planner component permission to access the at least one resource, the AI-based agent may not expose information of the at least one resource to other users without the first user's explicit permission. In some embodiments, in a group setting, the AI-based agent may be constrained by the minimal overlapping permissions of the full group of members. For example, the planner component in a group chat may not access information from at least one resource unless the at least one resource is already accessible by all users of the group.

In some embodiments, a user may be able to ask the AI-based agent to enter a private mode in their communication, in which case the communication with the AI-based agent and the information contained in it with regard to said user may only be accessed by the user, unless the AI-based agent is given explicit permissions otherwise.

In some embodiments, method 400 further comprises generating a duplicate of the one or more execution components of the AI-based agent and sharing the duplicated one or more execution components with other users. For example, once configured, a user may choose to duplicate the one or more execution components and share it with other users in the organization. In some embodiments, the user may also be able to share the one or more execution components with users outside of the organization, either directly or through one or more execution components marketplace function that is either included in a standalone application of the one or more execution components or is separate to it. The marketplace platform may include access to one or more execution components as a whole or to individual skills or abilities that they have developed. In such cases, the shared one or more execution components may include internal restrictions to prevent it from compromising the privacy and secrecy of the organizational and personal knowledge and data to which it had access or divulging these to unauthorized users outside of the organization.

In some embodiments, method 400 further comprises including the planner component and the one or more execution components in an API and sharing the application or the API with a plurality of users.

In some embodiments, method 400 further comprises receiving an input determined by the one or more execution components and updating the planning flow based on the input. For example, if the one or more execution components determines a user has submitted an input comprising a comment (e.g., text-based or audio-based) about at least one aspect of the planning flow, the planner component, accessing the one or more trained models, can updated the planning flow according to the comment. In a further example, the one or more execution components may determine an input from the AI-based agent itself comprising at least one learned element, wherein the learned element comes from the one or more execution components executing a previous similar task, subsequently allowing the planner component to access the one or more trained models in order to update the planning flow according to the learned element.

In some embodiments, method 400 further comprises requesting the user to identify supplemental information and receiving, based on an additional input from the user, an identifier of the supplemental information. The planning flow may be determined based on at least one aspect of the supplemental information.

In some embodiments, method 400 further comprises receiving feedback from the user on the at least one output, receiving, based on an additional input from the user, an identifier of an additional task and automatically determining, using the one or more trained models and based on the feedback, a new planning flow for executing the additional task. For example, the AI-based agent may infer the requirements of a user from feedback on the at least one output of a task, and consequently, automatically action the feedback when determining a new planning flow for a similar task in the future. Using the user feedback on the at least one output in such a way may require the AI-based agent to ask the user for fewer supplemental information or minimize the number of checkpoints for similar subsequent tasks.

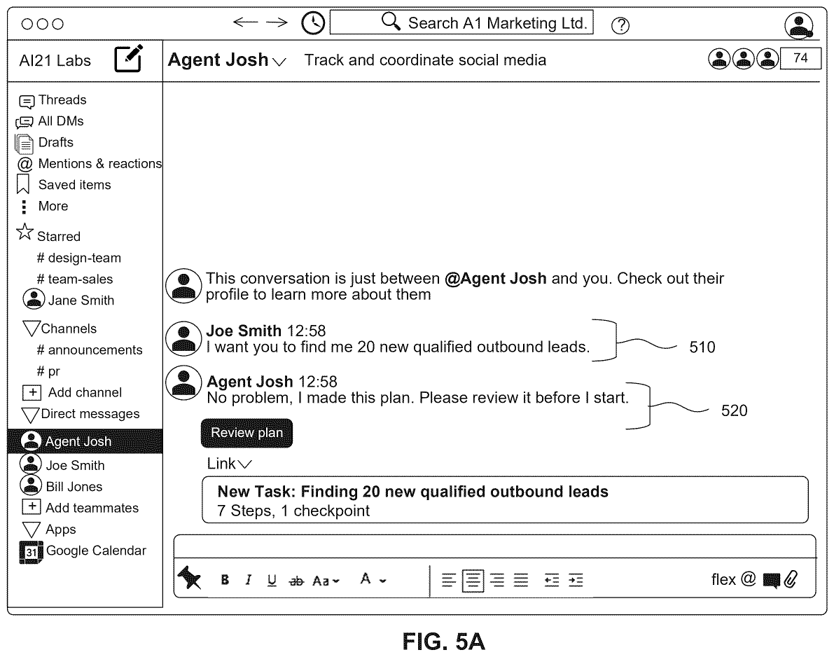

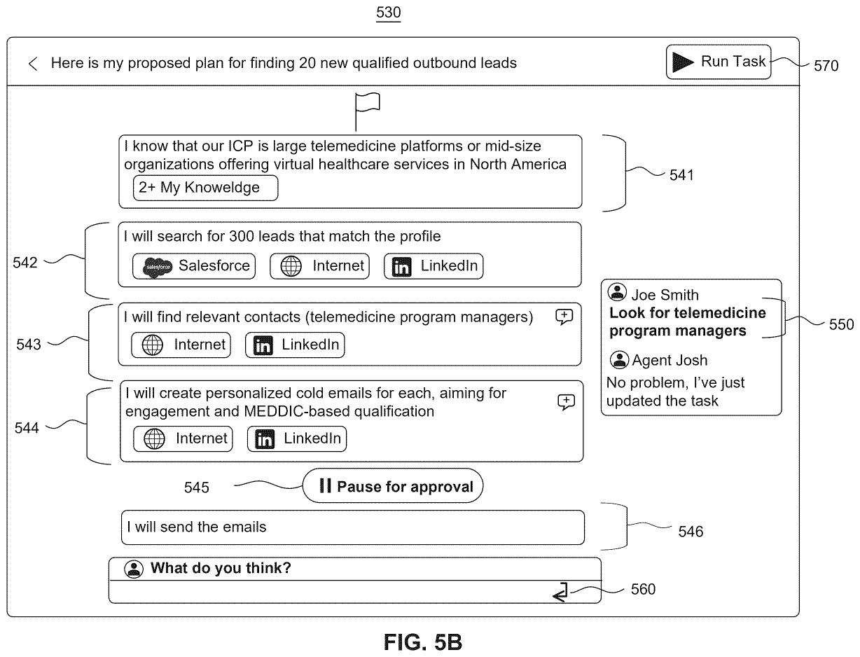

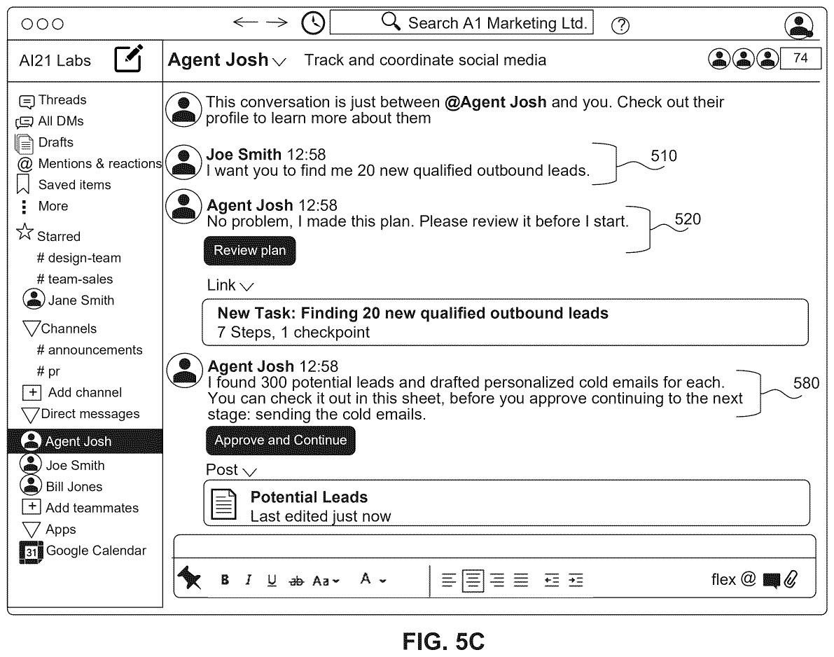

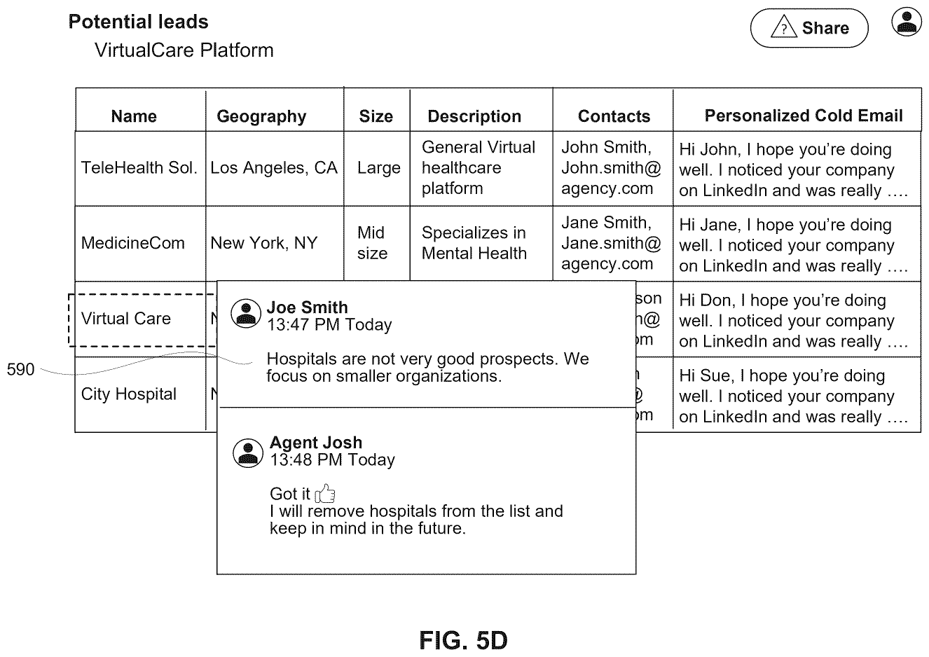

FIG. 5A-5D show representations of interacting with an AI-based agent according to disclosed embodiments. In FIG. 5A, which depicts an example interface, a user called “Joe Smith” interacts with an AI-based agent named “Agent Josh”. Joe Smith provides Agent Josh with a textual task 510, wherein the task reads “I want you to find me 20 new qualified outbound leads”. After being given task 510, Agent Josh responds to Joe Smith textually with response 520, in which Agent Josh offers for Joe Smith to review a planning flow for executing task 510.

FIG. 5B illustrates planning flow 530, generated by a planner component of Agent Josh in response to receiving task 510 by user Joe Smith. Planning flow 530 is visible to user Joe Smith. Planning flow 530 comprises a series of steps for executing task 510. For example, the first step 541 in the series of steps comprises a description of the extracted information relevant to task 510 the AI-based agent has stored in long-term memory. Second step 542 comprises a description of the first action the one or more execution components may undertake while executing task 510. Second step 542 further comprises a list of the resources the planner component accesses in order to create the particular step of the planning flow 530. Steps 543 and 544 also comprise a description of an action the one or more execution components may take as well as a list of resources the planner component may access. Steps 543 and 544 further comprise an option for the reviewing user to add a comment regarding the step in order for the planner component to update the step. For example, user Joe Smith adds the comment 550 “Look for telemedicine program managers” regarding step 543 of the series of steps. As a result, the planner component of Agent Josh updates the step 543 to recite “I will find relevant contacts (telemedicine program managers),” reflecting the user comment 550. Item 545 is a checkpoint at which execution of the task is paused for review by the user. For example, whilst the one or more execution components of Agent Josh executes the task according to planning flow 530, the execution may pause at checkpoint 545 for review of the result of preceding steps by user Joe Smith. Step 546 is the final step of the series of steps, describing the final action the one or more execution components may take in execution of task 510. Text-entry box 560 allows the user to provide feedback on the whole of planning flow 530. For example, given feedback from the user on the whole of planning flow 530, the planner component may update the planning flow 530 accordingly to reflect the feedback. In some embodiments, the feedback on the planning flow can be audio-based. Button 570 allows the user to instruct the one or more execution components of Agent Josh to execute the task according to the planning flow 530.

FIG. 5C depicts an example interface after the planner component has determined the planning flow and the one or more execution components has executed the task according to the planning flow until reaching a first checkpoint. In FIG. 5C, the AI-based agent, Agent Josh, provides user Joe Smith with response 580, allowing Joe Smith to review the result of the execution of task 510 according to planning flow 530 up until reaching checkpoint 545. This allows Joe Smith to further comment on the task execution before the one or more execution components of Agent Josh carries out the final step 546 of the series of steps of planning flow 530.

FIG. 5D depicts an information matrix depicting information resulting from executing the steps of planning flow 530 up until checkpoint 545, generated by Agent Josh and viewable by user Joe Smith. In FIG. 5D, Joe Smith submits comment 590 providing feedback on the information of the information matrix, wherein the information results from the one or more execution components of Agent Josh executing the steps of planning flow 530 up until checkpoint 545. As a result of comment 590, the planner component of Agent Josh updates the remainder of the planning flow 530 accordingly. In some embodiments, the one or more execution components may store the comment in long-term memory associated with the AI-based agent and automatically apply the comment in appropriate future tasks.

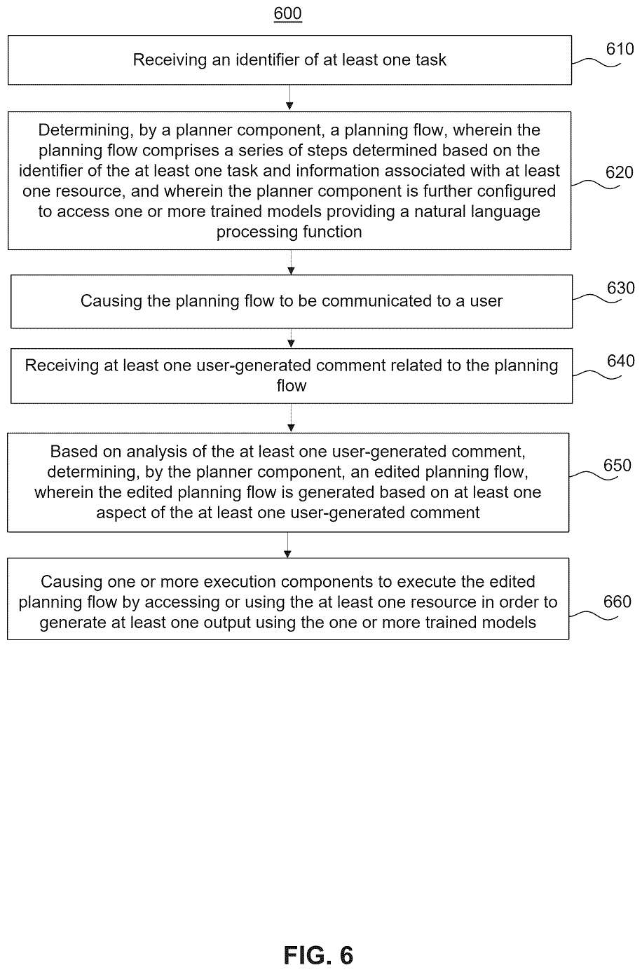

FIG. 6 is a flowchart showing another exemplary method 600 of performing a task using an AI-based agent, according to embodiments of the present disclosure. Method 600 may be performed by at least one processing device of a computing device (e.g., client device 110 or servers 140 of system 100). It is to be understood that throughout the present disclosure, the term “processor” is used as a shorthand for “at least one processor” or “one or more processors.” In other words, a processor may include one or more structures that perform logic operations whether such structures are collocated, connected, or dispersed. In some embodiments, a non-transitory computer readable medium may contain instructions that when executed by a processor cause the processor to perform method 600. Further, method 600 is not necessarily limited to the steps shown in FIG. 6, and any steps or processes of the various embodiments described throughout the present disclosure may also be included in method 600.

In some embodiments, method 600 begins at step 610 as shown in FIG. 6. At step 610, the one or more processing devices of system 100 receives an identifier of at least one task.

At step 620 of method 600, the one or more processing devices of system 100 determines, by a planner component, a planning flow. The planning flow may comprise a series of steps determined based on the identifier of the at least one task and information associated with at least one resource. The planner component may be further configured to access one or more trained models providing a natural language processing function.

At step 630 of method 600, the one or more processing devices of system 100 cause the planning flow to be communicated to a user.

At step 640 of method 600, the one or more processing devices of system 100 receive at least one user-generated comment related to the planning flow.

At step 650 of method 600, the one or more processing devices of system 100, based on analysis of the at least one user-generated comment, determine, by the planner component, an edited planning flow. The edited planning flow may be determined based on at least one aspect of the at least one user-generated comment.

At step 660 of method 600, the one or more processing devices of system 100 cause one or more execution components to execute the edited planning flow by accessing or using the at least one resource in order to generate at least one output using the one or more trained models.

In some embodiments, the identifier of the at least one task is received from the user. In some embodiments, the planner component and the one or more execution components of the AI-based agent include an API accessible by a user. For example, a user with a personal application may connect the one or more execution components API to a personal application in order to use the AI-based agent via their personal application. In some embodiments, the planner component and the one or more execution components includes an application. For example, the planner component and the one or more execution components of the AI-based agent includes a standalone application with its own GUI with which the user can interact. In some embodiments, the identifier is based on at least one of the user selecting a button within a GUI, the user submitting text within a text input window of a GUI, or the user submitting an audio input. For example, a user interacting with the AI-based agent may submit a task via a text entry window of a GUI, may upload an audio recording containing a task, may record in real-time audio containing a task or may select from a number of pre-defined tasks using buttons within a GUI. In some embodiments, the GUI may be a GUI of the AI-based agent, a GUI of the at least one resource, or a GUI of a personal application of the user. For example, a user that has connected an API of the AI-based agent to their personal application may interact with the AI-based agent using the GUI of their personal application. In some embodiments, the identifier includes a description of the at least one task.

In some embodiments, the at least one task is text-based or audio-based. In some embodiments, the at least one-task is text-based or audio-based. In some embodiments, the at least one task comprises one or more of a scheduling task, a research task, an administering a survey to other users task, a requesting other users for information task, a generating a forecast task, or a providing an analysis task.

In some embodiments, the planning flow is further based on at least one subject. In other embodiments, the at least one subject can be submitted via text or audio. Examples of the subjects the one or more execution components can specialize in include, but are not limited to, “purchasing”, “sales”, “marketing”, “research”, “customer success”, “human resources (HR)”, “compliance”, “general management”, “finance” or “administration”.

In some embodiments, the planning flow is communicated to the user via a display or audio. For example, the AI-based agent may show the user the planning flow via a GUI on a display or allow the user to listen to the planning flow via an audio file. In some embodiments, method 600 further comprises causing the edited planning flow to be shown to the user via a display.

In some embodiments, method 600 further comprises receiving an approval of the user to execute the edited planning flow. For example, the user may select a button within a GUI to signify approval of an edited planning flow or submit text or audio-based approval of an edited planning flow so that the one or more execution components subsequently executes the at least one task according to the edited planning flow.

In some embodiments, the at least one resource includes one or more of a word processor program, an electronic mail account, an instant messaging platform, a database, or an online source.

In some embodiments, determining the planning flow includes analyzing, using the one or more trained models, API documentation associated with an API of the at least one resource. For example, using one or more trained models providing a natural language processing function, the planner component can analyze and learn from documentation associated with an API of the at least one resource in order to connect the AI-based agent with the API of the at least one resource and subsequently access the information of the at least one resource in order to determine the planning flow.

In some embodiments, method 600 further comprises tracking a behavior of a user when accessing the at least one resource. For example, the planner component and/or the one or more execution components using one or more trained models can track the actions of a user interacting with, for example, a GUI of the at least one resource and subsequently learn how to independently use the GUI of the at least one resource in order for the planner component and/or the one or more execution components to access the information of the at least one resource.

In some embodiments, the at least one output conveys a meaning associated with at least one portion of the information associated with the at least one resource.

In some embodiments, exemplary method 600 further comprises causing the at least one output to be shown to a user via a display. Causing the at least one output to be shown to the user via a display may comprise causing the at least one output to be shown to the user via a GUI.

In some embodiments, the user-generated comment is one or more of text-based or audio-based. For example, in the case of FIG. 5B, comment 550 from user Joe Smith is text-based.

In some embodiments, the planning flow further comprises at least one checkpoint at which execution of the task is paused for review by the user. For example, at checkpoint 545 of FIG. 5B, the one or more execution components of Agent Josh may pause execution of the task up until the checkpoint of planning flow 530 for user Joe Smith to review the results of the preceding steps.

In some embodiments, method 600 further comprises, during execution of the at least one task, receiving, based on an additional input from the user, at least one request for a status update and providing the user with a status update. The status update may comprise information about a progress of execution of the series of steps. For example, a user may ask the AI-based agent for a progress update on how many of the series of steps of the planning flow the one or more execution components has executed.

In some embodiments, method 600 further comprises receiving an instruction from the user to create checkpoints in the planning flow. In some embodiments, method 600 further comprises receiving an instruction from the user to remove checkpoints in the planning flow. For example, the user may ask the AI-based agent to add additional checkpoints to the determined planning flow so that they may have further opportunities to review the results of the series of steps since the previous checkpoint. Alternatively, the user may ask the AI-based agent to remove existing checkpoints from the planning flow as they feel they do not need to review the results of the series of steps since the previous checkpoint.

In some embodiments, the at least one output generated by the one or more execution components includes one or more of text, an image, a video, an electronic mail message, audio, or code. In some embodiments, the at least one output includes causing an application to perform at least one action. For example, the generated output may comprise the one or more execution components interacting with at least one resource in order to carry out an action within the at least one resource. The at least one action can include, but is not limited to, updating an electronic calendar, editing a database, generating a proposal, generating a presentation, generating an executive summary, generating instructions for a product, among other things.

In some embodiments, the at least one output conveys a meaning associated with at least one portion of the information associated with the at least one resource.

In some embodiments, the one or more trained models include one or more trained machine learning models. In some embodiments, these one or more trained machine learning models include one or more large language models (LLMs).

In some embodiments, a user is able to test an ability of the planner component to access information associated with the at least one resource.

In yet more embodiments, the user can provide the planner component with examples of how to access or use the at least one resource. For example, the user submit to the AI-based agent examples of how to access or use the at least one resource, allowing the planner component to learn from the examples and subsequently independently access or use the at least one resource in order to, for example, access information of the at least one resource, or perform actions within the at least one resource.

In some embodiments, a user may be able to ask the AI-based agent to enter a private mode in their communication, in which case the communication with the AI-based agent and the information contained in it with regard to said user may only be accessed by the user, unless the AI-based agent is given explicit permissions otherwise.

In some embodiments, method 600 further comprises receiving an instruction from the user granting permission for a communication history between the user and the one or more execution components to be accessed by other users. In some embodiments, method 600 further comprises receiving an instruction from a user denying permission for the communications history between the user and the one or more execution components to be accessed by other users. In some embodiments, the other users comprise users inside a same organization as the user or users outside the organization of the user. For example, other users may be colleagues of the user in the same organization or may be outside the organization entirely.

In some embodiments, method 600 further comprises requesting the user to identify supplemental information and receiving, based on an additional input from the user, an identifier of the supplemental information. The planning flow may be determined based on at least one aspect of the supplemental information.

In some embodiments, method 600 further comprises receiving feedback from the user on the at least one output, receiving, based on an additional input from the user, an identifier of an additional task and automatically determining, using the one or more trained models and based on the feedback, a new planning flow for executing the additional task. For example, the AI-based agent may infer the requirements of a user from feedback on the at least one output of a task, and consequently, automatically action the feedback when determining a new planning flow for a similar task in the future. Using the user feedback on the at least one output in such a way may require the AI-based agent to ask the user for fewer supplemental information or minimize the number of checkpoints for similar subsequent tasks.

In some embodiments, method 600 further comprises extracting information associated with the at least one resource and storing the extracted information in a memory accessible by the one or more execution components. In some embodiments, the extracted information is visible to a user. In some embodiments, the extracted information can be shown to a user via a display. For example, the user can view the extracted information via a GUI on a display. In some embodiments, the extracted information is inaccessible to users who do not have permission to access the extracted information.

In some embodiments, method 600 further comprises receiving an input determined by the one or more execution components and updating the planning flow based on the input. For example, if the one or more execution components determines a user has submitted an input comprising a comment, wherein the comment is text-based or audio-based, about at least one aspect of the planning flow, the planner component, accessing the one or more trained models, can updated the planning flow according to the comment.

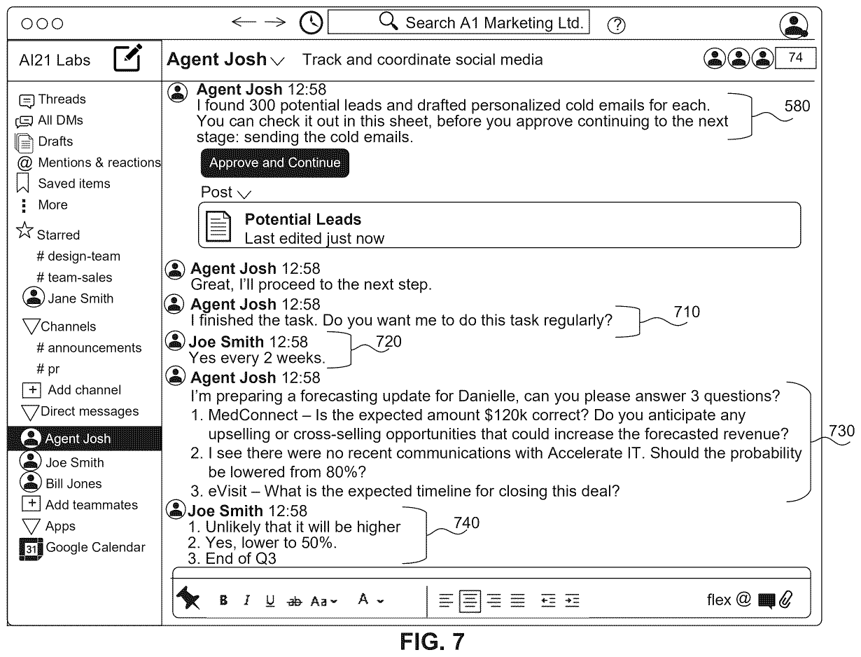

In the present disclosure, the AI-based agent may ask a user if a particular task should be carried out at regular time intervals. In FIG. 7 Agent Josh, at response 710, asks user Joe Smith if the executed task 510 should be performed at a regular interval. Joe Smith at response 720 gives a time interval to Agent Josh for which the agent should regularly carry out the task.

In the present disclosure, the one or more execution components of the AI-based agent may ask a user to identify supplemental information for executing a task. Again in FIG. 7, Agent Josh asks user Joe Smith in response 730 questions whose answers are required to execute a particular task. In detail, the task is “preparing a forecasting update for Danielle,” and the supplemental information is required to execute the task. This supplemental information is solicited from Joe Smith in the form of three questions. In response, Joe Smith is able to provide answers 740 In response to each question in order for Agent Josh to execute the task. In some embodiments, the AI-based agent solicits the supplemental information in the form of a textual comment or an audio recording. In some embodiments, the user-provided supplemental information is text-based or audio-based.

The above-described systems and method can be executed by computer program instructions that may also be stored in a computer readable medium (e.g., one or more hardware-based memory devices) that can direct a computer, other programmable data processing apparatus, or other devices to function in a particular manner, such that the instructions stored in the computer readable medium produce instructions which when implemented cause the one or more execution components to perform the above-described methods.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the above-described methods.

The foregoing description has been presented for purposes of illustration. It is not exhaustive and is not limited to the precise forms or embodiments disclosed. Modifications and adaptations will be apparent to those skilled in the art from consideration of the specification and practice of the disclosed embodiments. Additionally, although aspects of the disclosed embodiments are described as being stored in memory, one skilled in the art will appreciate that these aspects can also be stored on other types of computer readable media, such as secondary storage devices, for example, hard disks or CD ROM, or other forms of RAM or ROM, USB media, DVD, Blu-ray, 4K Ultra HD Blu-ray, or other optical drive media.

Computer programs based on the written description and disclosed methods are within the skill of an experienced developer. The various programs or program modules can be created using any of the techniques known to one skilled in the art or can be designed in connection with existing software. For example, program sections or program modules can be designed in or by means of .Net Framework, .Net Compact Framework (and related languages, such as Visual Basic, C, etc.), Java, C++, Objective-C, HTML, HTML/AJAX combinations, XML, or HTML with included Java applets.

Moreover, while illustrative embodiments have been described herein, the scope of any and all embodiments having equivalent elements, modifications, omissions, combinations (e.g., of aspects across various embodiments), adaptations and/or alterations as would be appreciated by those skilled in the art based on the present disclosure. The limitations in the claims are to be interpreted broadly based on the language employed in the claims and not limited to examples described in the present specification or during the prosecution of the application. The examples are to be construed as non-exclusive. Furthermore, the steps of the disclosed methods may be modified in any manner, including by reordering steps and/or inserting or deleting steps. It is intended, therefore, that the specification and examples be considered as illustrative only, with a true scope and spirit being indicated by the following claims and their full scope of equivalents.

What is claimed is:

1. A non-transitory computer-readable medium including instructions that when executed by one or more processing devices cause the one or more processing devices to perform a method, the method comprising:
receiving an identifier of at least one task;
determining, by a planner component, a planning flow, wherein the planning flow comprises a series of steps determined based on the identifier of the at least one task and information associated with at least one resource, and wherein the planner component is further configured to access one or more trained models providing a natural language processing function; and
causing one or more execution components to execute the planning flow by accessing or using the at least one resource in order to generate at least one output using the one or more trained models.

2. The non-transitory computer-readable medium of claim 1, wherein the identifier of the at least one task is received from a user.

3. The non-transitory computer-readable medium of claim 2, wherein the identifier is based on at least one of the user selecting a button within a graphical user interface (GUI), the user submitting text within a text input window of a GUI, or the user submitting an audio input.

4. The non-transitory computer-readable medium of claim 1, wherein the identifier includes a description of the at least one task.

5. The non-transitory computer-readable medium of claim 1, the method further comprising:
extracting information associated with the at least one resource; and
storing the extracted information in a memory accessible by the one or more execution components.

6. The non-transitory computer-readable medium of claim 5, wherein the extracted information is inaccessible to users who do not have permission to access the extracted information.

7. The non-transitory computer-readable medium of claim 1, wherein the at least one task is text-based or audio-based.

8. The non-transitory computer-readable medium of claim 1, wherein the at least one task comprises one or more of a scheduling task, a research task, an administering a survey to other users task, a requesting other users for information task, a generating a forecast task, or a providing an analysis task.

9. The non-transitory computer-readable medium of claim 1, wherein the planner component and the one or more execution components are included in an application.

10. The non-transitory computer-readable medium of claim 1, wherein the planner component and the one or more execution components are included in an application programming interface (API).

11. The non-transitory computer-readable medium of claim 1, wherein the planning flow is further based on at least one subject.

12. The non-transitory computer-readable medium of claim 11, wherein the at least one subject includes one or more of purchasing, sales, marketing, research, customer success, human resources, compliance, general management, finance, or administration.

13. The non-transitory computer-readable medium of claim 1, wherein the at least one resource includes one or more of a word processor program, an electronic mail account, an instant messaging platform, a database, or an online source.

14. The non-transitory computer-readable medium of claim 13, wherein the database is associated with organizational information or personal information of a user.

15. The non-transitory computer-readable medium of claim 1, wherein determining the planning flow includes analyzing, using one or more trained models, API documentation associated with an API of the at least one resource.

16. The non-transitory computer-readable medium of claim 1, the method further comprising tracking a behavior of a user when accessing the at least one resource.

17. The non-transitory computer-readable medium of claim 1, the method further comprising causing the planning flow to be shown to a user via a display.

18. The non-transitory computer-readable medium of claim 1, the method further comprising causing the at least one output to be shown to a user via a display.

19. The non-transitory computer-readable medium of claim 18, wherein causing the at least one output to be shown to the user via a display comprises causing the at least one output to be shown to the user via a graphical user interface (GUI).

20. The non-transitory computer-readable medium of claim 1, wherein the one or more execution components are configured to execute the planning flow in response to an instruction received from a user.

21. The non-transitory computer-readable medium of claim 20, where the instruction includes a request for information.

22. The non-transitory computer-readable medium of claim 20, wherein the instruction includes a request to perform at least one action.

23. The non-transitory computer-readable medium of claim 1, wherein the at least one output includes text.

24. The non-transitory computer-readable medium of claim 1, wherein the at least one output includes an image, a video, audio, or code.

25. The non-transitory computer-readable medium of claim 1, wherein the at least one output includes an electronic mail message.

26. The non-transitory computer-readable medium of claim 1, wherein the at least one output includes causing an application to perform at least one action.

27. The non-transitory computer-readable medium of claim 26, wherein the at least one action includes updating an electronic calendar.

28. The non-transitory computer-readable medium of claim 26, wherein the at least one action includes editing a database.

29. The non-transitory computer-readable medium of claim 1, wherein the at least one output conveys a meaning associated with at least a portion of information associated with the at least one resource.

30. The non-transitory computer-readable medium of claim 1, wherein the one or more trained models include one or more trained machine learning models.

31. The non-transitory computer-readable medium of claim 30, wherein the one or more trained machine learning models include one or more large language models (LLMs).

32. The non-transitory computer-readable medium of claim 1, wherein a user tests an ability of the planner component to access information associated with the at least one resource.

33. The non-transitory computer-readable medium of claim 1, wherein a user provides the planner component with examples of how to access or use the at least one resource.

34. The non-transitory computer-readable medium of claim 1, wherein the one or more execution components are further configured to interact sequentially with a plurality of users.

35. The non-transitory computer-readable medium of claim 1, the method further comprising receiving an instruction from a user granting permission for a communication history between the user and the one or more execution components to be accessed by other users.

36. The non-transitory computer-readable medium of claim 1, the method further comprising receiving an instruction from a user denying permission for communications between the user and the one or more execution components to be accessed by other users.

37. The non-transitory computer-readable medium of claim 1, the method further comprising:
including the planner component and the one or more execution components in an application or an application programming interface (API); and
sharing the application or the API with a plurality of users.

38. The non-transitory computer-readable medium of claim 1, the method further comprising:
receiving an input determined by the one or more execution components; and
updating the planning flow based on the input.

39. The non-transitory computer-readable medium of claim 1, the method further comprising:
requesting a user to identify supplemental information; and
receiving, based on an additional input from the user, an identifier of the supplemental information, wherein the planning flow is determined based on at least one aspect of the supplemental information.

40. The non-transitory computer-readable medium of claim 1, the method further comprising:
receiving feedback from a user on the at least one output;
receiving, based on an additional input from the user, an identifier of an additional task; and
automatically determining, using the one or more trained models and based on the feedback, a new planning flow for executing the additional task.

41. A non-transitory computer-readable medium including instructions that when executed by one or more processing devices cause the one or more processing devices to perform a method, the method comprising:
receiving an identifier of at least one task;
determining, by a planner component, a planning flow, wherein the planning flow comprises a series of steps determined based on the identifier of the at least one task and information associated with at least one resource, and wherein the planner component is further configured to access one or more trained models providing a natural language processing function;
causing the planning flow to be communicated to a user;
receiving at least one user-generated comment related to the planning flow;
based on analysis of the at least one user-generated comment, determining, by the planner component, an edited planning flow, wherein the edited planning flow is determined based on at least one aspect of the at least one user-generated comment; and
causing one or more execution components to execute the edited planning flow by accessing or using the at least one resource in order to generate at least one output using the one or more trained models.

42. The non-transitory computer-readable medium of claim 41, wherein the identifier of the at least one task is received from the user.

43. The non-transitory computer-readable medium of claim 41, wherein the identifier includes a description of the at least one task.

44. The non-transitory computer-readable medium of claim 41, wherein the identifier is based on at least one of the user selecting a button within a GUI, the user submitting text within a text input window of a GUI, or the user submitting an audio input.

45. The non-transitory computer-readable medium of claim 41, wherein the at least one task is text-based or audio-based.

46. The non-transitory computer-readable medium of claim 41, wherein the at least one task comprises one or more of a scheduling task, a research task, an administering a survey to other users task, a requesting other users for information task, a generating a forecast task, or a providing an analysis task.

47. The non-transitory computer-readable medium of claim 41, wherein the planner component and the one or more execution components are included in an application.

48. The non-transitory computer-readable medium of claim 41, wherein the planner component and the one or more execution components are included in an application programming interface (API).

49. The non-transitory computer-readable medium of claim 41, wherein the planning flow is further based on at least one subject, wherein the at least one subject includes one or more of purchasing, sales, marketing, research, customer success, human resources, compliance, general management, finance, or administration.

50. The non-transitory computer-readable medium of claim 41, wherein the planning flow is communicated to the user via a display or via audio.

51. The non-transitory computer-readable medium of claim 41, the method further comprising causing the edited planning flow to be shown to the user via a display.

52. The non-transitory computer-readable medium of claim 41, the method further comprising receiving an approval of the user to execute the edited planning flow.

53. The non-transitory computer-readable medium of claim 41, wherein the at least one resource includes one or more of a word processor program, an electronic mail account, an instant messaging platform, a database, or an online source.

54. The non-transitory computer-readable medium of claim 41, wherein determining the planning flow includes analyzing, using the one or more trained models, API documentation associated with an API of the at least one resource.

55. The non-transitory computer-readable medium of claim 41, wherein the method further comprising tracking a behavior of the user when accessing the at least one resource.

56. The non-transitory computer-readable medium of claim 41, wherein the at least one output conveys a meaning associated with the at least one resource.

57. The non-transitory computer-readable medium of claim 41, the method further comprising causing the at least one output to be shown to a user via a display.

58. The non-transitory computer-readable medium of claim 41, wherein the user-generated comment is one or more of text-based or audio-based.

59. The non-transitory computer-readable medium of claim 41, wherein the planning flow comprises at least one checkpoint at which execution of the task is paused for review by user.

60. The non-transitory computer-readable medium of claim 41, the method further comprising:
during execution of the at least one task, receiving, based on an additional input from the user, at least one request for a status update; and
providing the user with a status update, wherein the status update comprises information about a progress of execution of the series of steps.

61. The non-transitory computer-readable medium of claim 41, the method further comprising receiving an instruction from the user to create checkpoints in the planning flow.

62. The non-transitory computer-readable medium of claim 41, the method further comprising receiving an instruction from the user to remove checkpoints in the planning flow.

63. The non-transitory computer-readable medium of claim 41, wherein the at least one output includes text, an image, or a video.

64. The non-transitory computer-readable medium of claim 41, wherein the at least one output includes an electronic mail message, audio, or code.

65. The non-transitory computer-readable medium of claim 41, wherein the at least one output includes causing an application to perform at least one action.

66. The non-transitory computer-readable medium of claim 65, wherein the at least one action includes updating an electronic calendar.

67. The non-transitory computer-readable medium of claim 65, wherein the at least one action includes editing a database.

68. The non-transitory computer-readable medium of claim 41, wherein the at least one output conveys a meaning associated with at least a portion of the information associated with the at least one resource.

69. The non-transitory computer-readable medium of claim 41, wherein the one or more trained models include one or more trained machine learning models.

70. The non-transitory computer-readable medium of claim 69, wherein the one or more trained machine learning models include one or more large language models (LLMs).

71. The non-transitory computer-readable medium of claim 41, wherein the user tests an ability of the planner component to access information associated with at least one resource to determine the planning flow.

72. The non-transitory computer-readable medium of claim 41, wherein the user provides the planner component with examples of how to use the at least one resource.

73. The non-transitory computer-readable medium of claim 41, the method further comprising receiving an instruction from the user granting permission for a communication history between the user and the one or more execution components to be accessed by other users.

74. The non-transitory computer-readable medium of claim 41, the method further comprising receiving an instruction from the user denying permission for communications between the user and the one or more execution components to be accessed by other users.

75. The non-transitory computer-readable medium of claim 41, the method further comprising:
extracting information associated with the at least one resource; and
storing the extracted information in a memory accessible by the one or more execution components.

76. The non-transitory computer-readable medium of claim 41, the method further comprising:
requesting the user to identify supplemental information; and
receiving, based on an additional input from the user, an identifier of the supplemental information, wherein the edited planning flow is determined based on at least one aspect of the supplemental information.

77. The non-transitory computer-readable medium of claim 41, the method further comprising:
receiving feedback from the user on the at least one output;
receiving, based on an additional input from the user, an identifier of an additional task; and
automatically determining, using the one or more trained models and based on the feedback, a new planning flow for executing the additional task.

78. The non-transitory computer-readable medium of claim 41, the method further comprising:
receiving an input determined by the one or more execution components; and
updating the planning flow based on the input.
